(19) United States
(12) Patent Application Publication
(10) Pub. No.: US 2018/0259244 A1
(43) Pub. Date: Sep. 13, 2018

(54) REFRIGERATOR

(71) Applicant: Samsung Electronics Co., Ltd., Suwon-si (KR)

(72) Inventors: Min Soo KIM, Seoul (KR); Yang-Yeol GU, Gwangju (KR); Byung Mo YU, Suwon-si (KR)

(21) Appl. No.: 15/918,907

(22) Filed: Mar. 12, 2018

(30) Foreign Application Priority Data
Mar. 10, 2017 (KR) 10-2017-0030664

(51) Int. Cl. F25D 23/08; F25D 21/04; F25D 23/02; E06B 7/23

(52) U.S. Cl. CPC F25D 23/087; F25D 21/04; E05C 19/161; E06B 7/2307; F25D 23/028

(57) ABSTRACT

Disclosed herein is a refrigerator having a gasket having an improved structure. The refrigerator includes a cabinet provided with an outer case and an inner case, a storage compartment provided inside of the cabinet, a door rotatably coupled to the cabinet to open or close the storage compartment and provided with a coupling groove disposed on a rear surface of the door, and a gasket mounted to the coupling groove to close the storage compartment. The gasket includes an insertion member inserted into the coupling groove and provided with a contact surface configured to be in close contact with one side of the coupling groove, a hook provided on a side opposite to the contact surface to be coupled to the other side of the coupling groove, and a wing protrusion obliquely extended from one end side of the insertion member.

### CROSS-REFERENCE TO RELATED APPLICATION AND CLAIM OF PRIORITY

This application is based on and claims priority under 35 U.S.C. §119 to Korean Patent Application No. 10-2017-0030664, filed on Mar. 10, 2017, in the Korean Intellectual Property Office, the disclosure of which is incorporated by reference herein in its entirety.

### TECHNICAL FIELD

Embodiments of the present disclosure relate to a refrigerator, more particularly to a refrigerator having a gasket with an improved structure.

### BACKGROUND

A refrigerator is a household appliance that can keep food fresh by having a storage compartment for storing food, and a cold supply device for supplying cold air to the storage compartment.

A temperature of the storage compartment should be maintained at a temperature within the range required to keep the food fresh. The storage compartment is provided such that a front surface thereof is open, and the open front surface is normally closed by a door to maintain the temperature of the storage compartment.

A gasket is a component disposed between a cabinet and a door of a refrigerator to prevent cold air from leaking into a space between the cabinet and the door upon closing the door, and to mitigate the impact applied to the door and the cabinet when the door is opened or closed.

The gasket minimizes the heat transmission caused by the temperature difference between the outside of the refrigerator and the inside of the refrigerator, thereby reducing the energy consumption of the refrigerator.

Since the gasket is formed of an elastic material, the gasket may be configured to cope with a change in the distance between the cabinet and the door.

The gasket may include a buffer portion having a wrinkle structure for preventing the leakage of the cold air, improving the sealing force, minimizing the heat loss, and securing the opening force of the door.

An inside of the buffer portion has a complicated partition structure so that the gasket absorbs the impact generated by the bump of the door and the cabinet upon opening and closing the door, and minimizes the heat loss caused by the temperature difference between the inside and the outside of the cabinet upon opening and closing the door.

The gasket may be manufactured by extrusion molding to have a complicated partition structure disposed therein.

Since a hook configured to allow the gasket to be mounted to the door is provided opposite sides of the gasket, a width of a front surface of the gasket may become large and thus the aesthetic quality of the appearance of the refrigerator may be reduced.

As the gasket has a substantially rectangular shape between the door and the cabinet, a height of the side surface of the gasket, which is exposed upon closing the door, may be increased, and thus the aesthetic quality of the appearance of the refrigerator may be reduced.

Due to a relatively large width of the front surface and a relatively large height of the side surface of the gasket, the gasket may be vulnerable to dew condensation and thus it may be possible to reduce the heat insulating performance.

### SUMMARY

Therefore, it is an aspect of the present disclosure to provide a refrigerator having an improved gasket configured to prevent deterioration of the exterior design of the refrigerator without changing the structure of the cabinet.

It is another aspect of the present disclosure to provide a refrigerator having an improved gasket configured to reduce the dew condensation without changing the structure of the cabinet.

Additional aspects of the present disclosure will be set forth in part in the description which follows and, in part, will be obvious from the description, or may be learned by practice of the invention.

In accordance with one aspect of the present disclosure, a refrigerator includes a cabinet provided with an outer case and an inner case; a storage compartment provided inside of the cabinet to have an opened front surface; a door rotatably coupled to the cabinet to open and close the storage compartment and provided with a coupling groove disposed on a rear surface of the door; and a gasket mounted to the coupling groove to maintain the sealing force of the storage compartment, wherein the gasket includes an insertion member inserted into the coupling groove; a hook provided on a side of the insertion member to be locked -coupled to the coupling groove; a contact surface provided on the other side of the insertion member to be opposite to the hook and configured to be in close contact with the coupling groove to reduce a width of a front surface of the gasket, which is exposed to the outside upon opening the door; and a wing protrusion obliquely extended from one end side of the insertion member to the cabinet to reduce a height of a side surface of the gasket, which is exposed to the outside upon closing the door.

The gasket may be formed in a wedge shape wherein the height of the side surface of the gasket is reduced as the gasket becomes near to the outer edge of the door.

The height of the side surface of the gasket, which is exposed to the outside upon closing the door, may be approximately 3 mm˜5 mm.

The coupling groove may include a locking protrusion configured to support the hook and a coupling surface disposed opposite to the locking protrusion and to be in surface contact with the contact surface.

The width of the front surface of the gasket, which is exposed to the outside upon opening the door, may be approximately 10 mm˜14 mm.

The door may include an inner panel wing obliquely extended from the locking protrusion to one side edge of the door and configured to be in surface contact with the wing protrusion.

The door may include an outer panel wing obliquely provided to be in surface contact with inner panel wing, and a covering surface bent from the outer panel wing and extended toward one side edge of the door.

A width of the covering surface may be greater than the width of the front surface of the gasket.

The outer panel wing may be inclined at equal to or greater than approximately 25 degree toward the other side edge of the door with respect to the covering surface.

The gasket may include a magnet accommodating portion configured to accommodate a magnet and installed to be in close contact with the outer case, and a buffer portion adjacent to the magnet accommodating portion and configured to accommodate a buffer member having a thermal conductivity lower than that of air.

The cabinet may further include a hot line disposed between the outer case and the inner case, wherein the hot line may be mounted to the door wherein the hot wire is placed by corresponding to the width of the front surface of the gasket upon closing the door.

The buffer portion may include an elastic member so that the gasket has a stretching structure configured to absorb the impact occurred upon closing and opening the door.

A height of the gasket, which is stretched by the elastic member upon closing and opening the door, may be equal to or greater than approximately 4 mm.

The refrigerator may further include an inner panel liner bent from the coupling surface and extended toward the other outer edge of the door upon closing the door and a cavity formed to have a first distance between the inner panel liner and the inner case opposite to the inner panel liner.

A second distance between the covering surface and the outer case opposite to the covering surface may be the same as the first distance, so as to achieve the unity in the overall design on the rear surface of the door.

In accordance with another aspect of the present disclosure, a refrigerator includes a cabinet provided with an outer case and an inner case and configured to accommodate a storage compartment therein; a door configured to open and close the storage compartment and provided with a door inner panel and a door outer panel; and a gasket installed between the cabinet and the door to maintain the sealing force of the storage compartment, wherein the door includes a coupling groove disposed inside of a rear surface of the door; a covering surface bent from one end portion of the door outer panel and extended toward the inside, and configured to be opposed in parallel with the outer case upon closing the door; an outer panel wing bent from the covering surface and obliquely extended to the inside; and an inner panel wing obliquely provided to be in surface contact with the outer panel wing.

The gasket may include a buffer portion configured to absorb an impact occurred upon closing the door, and a coupling portion adjacent to the buffer portion and mounted to the coupling groove by having a wing protrusion obliquely provided to be in surface contact with the inner panel wing.

The coupling portion may include a contact surface configured to be in parallel contact with one side of the coupling groove so as to reduce a width of a front surface of the gasket, which is exposed to the outside upon opening the door.

In accordance with another aspect of the present disclosure, a refrigerator includes a cabinet; a door rotatably coupled to the cabinet and provided with a locking protrusion disposed inside of an edge of a rear surface thereof and a coupling surface formed in a flat shape and opposite to the locking protrusion; and a gasket provided with a hook configured to be locked to the locking protrusion, so as to be mounted to the door, wherein the gasket includes a contact surface disposed opposite to the hook and configured to be in parallel contact with the coupling surface, so as to reduce a first length corresponding to a width of a front surface of the gasket.

The gasket may have a shape in which a height thereof is reduced from the contact surface to the outer edge of the door, so as to reduce a second length corresponding to a height of a side surface of the gasket, which is exposed to the outside.

### BRIEF DESCRIPTION OF THE DRAWINGS

These and/or other aspects of the disclosure will become apparent and more readily appreciated from the following description of embodiments, taken in conjunction with the accompanying drawings of which:

FIG. 1 is a perspective view of a refrigerator according to an embodiment.

FIG. 2 is a side cross-sectional view of the refrigerator according to an embodiment.

FIG. 3 is an exploded view illustrating a door and a gasket according to an embodiment.

FIG. 4 is a view illustrating a case in which a door and a gasket are coupled in a refrigerator according to a first embodiment.

FIG. 5 is a view illustrating the cabinet and the gasket upon closing the door in the refrigerator according to the first embodiment.

FIG. 6 is a view illustrating a case in which the cabinet and the gasket when the door is opened in the refrigerator according to the first embodiment.

FIG. 7 is a view illustrating a stretching structure of the gasket in the refrigerator according to the first embodiment.

FIG. 8 is a view illustrating a cabinet and a gasket when a door is closed in a refrigerator according to a second embodiment.

FIG. 9 is a view illustrating a cabinet and a gasket when a door is closed in a refrigerator according to a third embodiment.

FIG. 10 is a view illustrating a cabinet and a gasket when a door is closed in a refrigerator according to a fourth embodiment.

### DETAILED DESCRIPTION

Embodiments described in the present disclosure and configurations shown in the drawings are merely examples of the embodiments of the present disclosure, and may be modified in various different ways at the time of filing of the present application to replace the embodiments and drawings of the present disclosure.

In addition, the same reference numerals or signs shown in the drawings of the present disclosure indicate elements or components performing substantially the same function. Also, the terms used herein are used to describe the embodiments and are not intended to limit and/or restrict the present disclosure.

The singular forms “a,” “an” and “the” are intended to include the plural forms as well, unless the context clearly indicates otherwise. In this present disclosure, the terms “including”, “having”, and the like are used to specify features, numbers, steps, operations, elements, components, or combinations thereof, but do not preclude the presence or addition of one or more of the features, elements, steps, operations, elements, components, or combinations thereof.

It will be understood that, although the terms first, second, third, etc., may be used herein to describe various elements, but elements are not limited by these terms. These terms are only used to distinguish one element from another element.

For example, without departing from the scope of the present disclosure, a first element may be termed as a second element, and a second element may be termed as a first element.

The term of “and/or” includes a plurality of combinations of relevant items or any one item among a plurality of relevant items.

In the following detailed description, the terms of “front end”, “rear end”, “upper portion”, “lower portion” and the like may be defined by the drawings, but the shape and the location of the component is not limited by the term.

The present disclosure will be described more fully hereinafter with reference to the accompanying drawings.

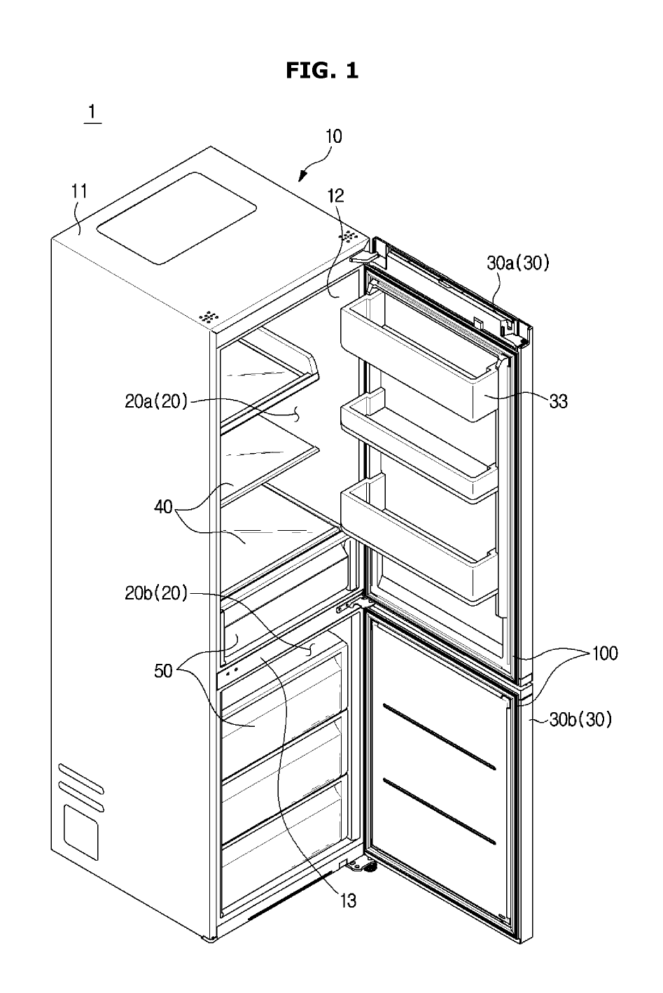

FIG. 1 is a perspective view of a refrigerator according to an embodiment. As illustrated in FIG. 1, a refrigerator 1 may include a cabinet 10 and a storage compartment 20 provided inside of the cabinet 10 to have an opened front surface thereof so that goods is inserted thereinto or pull out therefrom.

The refrigerator 1 may include a door 30 rotatably coupled to the cabinet 10 to open and close the opened front surface of the storage compartment 20, and a cool air supply apparatus to supply cool air to the storage compartment 20.

The cabinet 10 may include an outer case 11 and an inner case 12. The outer case 11 may form an exterior of the cabinet 10. The outer case 11 may be formed of a metal material having the durability and the beauty.

The inner case 12 may be placed inside of the outer case 11. The inner case 12 may form an exterior of the storage compartment 20. The inner case 12 may be formed of plastic material by being integrally injection molded.

The storage compartment 20 may be divided into a plurality of storage compartments 20 by a partition 13. The storage compartment 20 may include an upper storage compartment 20a and a lower storage compartment 20b. The upper storage compartment 20a and the lower storage compartment 20b each may be divided into a left storage compartment and a right storage compartment by other partition (not shown).

The storage compartment 20 may include a refrigerating compartment and a freezing compartment. According to the refrigerator type, the upper storage compartment 20a is provided as the refrigerating compartment and the lower storage compartment 20b is provided as the freezing compartment, or alternatively, the upper storage compartment 20a is provided as the freezing compartment and the lower storage compartment 20b is provided as the refrigerating compartment.

As illustrated in FIG. 1, the refrigerator 1 is the bottom freezer type in which the upper storage compartment 20a is provided as the refrigerating compartment and the lower storage compartment 20b is provided as the freezing compartment.

However, the type of the refrigerator is not limited thereto. Therefore, embodiments of the present disclosure may be applied to different refrigerator types.

The different refrigerator type may include a side by side type in which a refrigerating compartment and a freezing compartment are disposed in the left and right side, and a top mounted freezer type in which a freezing compartment is disposed in the upper side of refrigerating compartment.

The freezing compartment may be maintained at approximately −20° C. and the refrigerating compartment may be maintained at approximately 3° C. The refrigerating compartment and the freezing compartment may be insulated by the partition 13.

The storage compartment 20 may be opened or closed by the door 30. The upper storage compartment 20a may be opened or closed by an upper door 30a rotatably coupled to the cabinet 10. The lower storage compartment 20b may be opened or closed by a lower door 30b coupled to the cabinet 10.

However, the configuration of the upper door and the lower door are not limited thereto. The upper storage compartment 20a or the lower storage compartment 20b may be opened or closed by a draw type upper door or lower door coupled to the cabinet 10 in a sliding manner, and the upper door 30a or the lower door 30b may be provided in a pair. Therefore, the configuration of the door 30 may vary as long as capable of opening and closing the storage compartment 20.

The door 30 may be rotatably coupled to the cabinet 10 by a hinge unit (not shown), wherein the hinge unit (not shown) may include an upper hinge (not shown), a middle hinge (not shown) and a lower hinge (not shown).

On the rear surface of the upper door 30a, a plurality of door guards 33 may be provided to store goods. Particularly, the door guard 33 may be configured to store goods having the small volume.

In the storage compartment 20, a shelf assembly 40 may be provided to support goods stored in the storage compartment 20. A plurality of shelf assemblies 40 may be provided. The shelf assembly 40 may be installed in the refrigerating compartment or the freezing compartment.

A drawer type storage container 50 storing vegetables and fruits may be installed inside of the storage compartment 20. The storage container 50 may be provided in a closed type wherein goods are stored in a closed inner space. The storage container 50 may be installed in the refrigerating compartment or the freezing compartment.

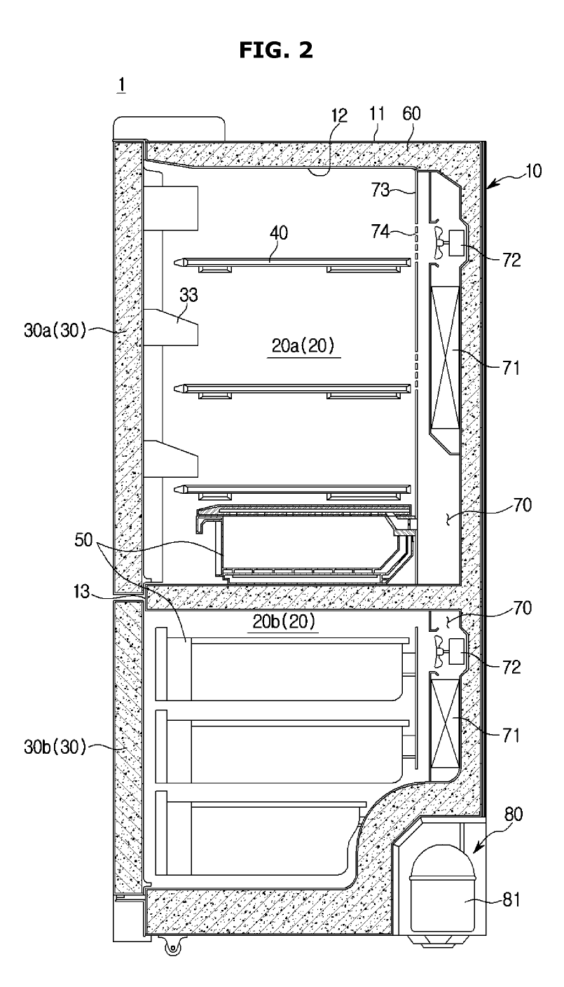

FIG. 2 is a side cross-sectional view of the refrigerator according to an embodiment.

As illustrated in FIG. 2, an insulation material 60 may be foamed between the inner case 12 and the outer case 11 to prevent cold air of the storage compartment 20 from being leaked.

The cool air supply apparatus may supply cold air to the storage compartment 20. Generally, the refrigerator 1 may include a cool air supply apparatus provided therein. The refrigerator 1 may refrigerate and freeze goods stored inside of the storage compartment 20 by using cold air generated by the cool air supply apparatus.

A cooling air circulation system 70 may be disposed in the rear side of the storage compartment 20. An evaporator 71 refrigerating the storage compartment 20 may be installed in the rear side of the cooling air circulation system 70.

A blower fan 72 circulating the internal air of the storage compartment 20 may be provided in an upper side of the evaporator 71. In the front side of the evaporator 71, a panel 73 may be installed to separate the inner space into the cooling air circulation system 70 and the storage compartment 20.

A cool air discharging portion 74 may be disposed in the panel 73 to discharge cold air, which is guided via the cooling air circulation system 70, to the storage compartment 20. The blower fan 72 may blow air, which is passed through the evaporator 71, to the cooling air circulation system 70.

A machinery room 80 separated from the storage compartment 20 may be provided in the lower portion of the cabinet 10. In the machinery room 80, a compressor 81 configured to compress refrigerant, a condenser (not shown) configured to condense the compressed refrigerant, and a refrigerant expansion device (not shown) configured to expand the compressed refrigerant may be installed.

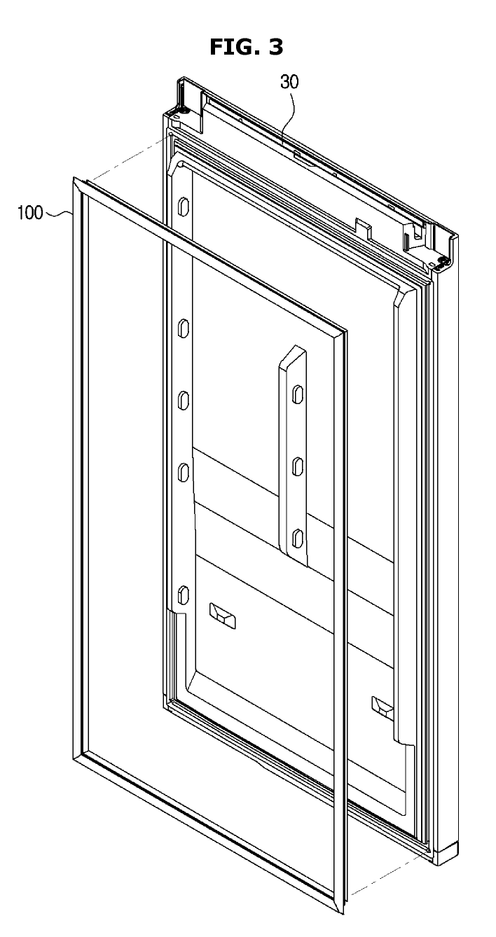

FIG. 3 is an exploded view illustrating a door and a gasket according to an embodiment. As illustrated in FIG. 3, a gasket 100 may be installed on the door 30 to maintain the sealing force between the storage compartment 20 and the outside and to absorb the impact occurred upon opening or closing the door.

The gasket 100 may be mounted on a rear surface of the door 30. The gasket 100 may be installed on both the upper door 30a and the lower door 30b.

Generally, the gasket 100 may be a sealing member, and used to prevent the leakage of a fluid, in a junction between two surfaces. A material for the gasket 100 may include asbestos, cotton, hemp, a rubber, and various synthetic resins, and the material may be selected according to conditions such as use.

The gasket 100 may be provided in a rectangular shape having an opening in the middle thereof to correspond to the shape of the door 30, but is not limited thereto.

The gasket 100 may be manufactured by extrusion molding. The gasket 100 may be integrally formed, or alternatively, may be separately formed as a plurality of portions and then coupled to each other.

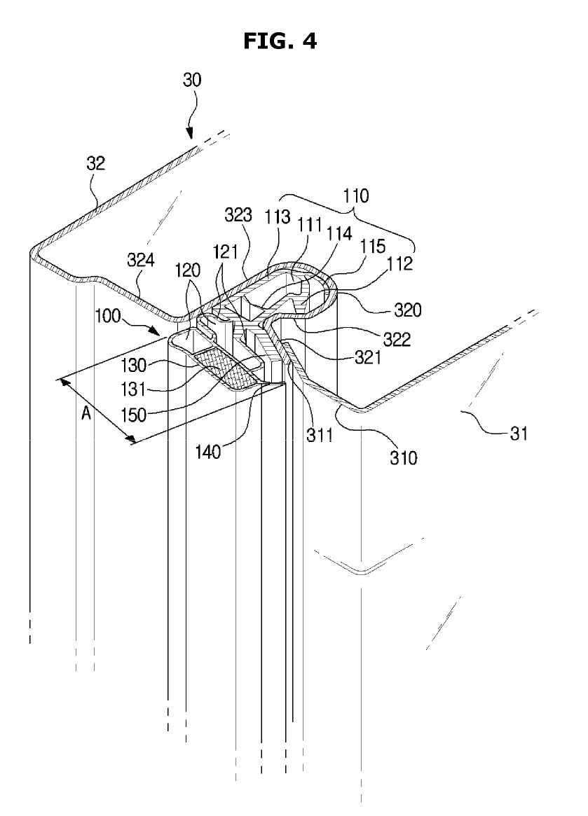

FIG. 4 is a view illustrating a case in which a door and a gasket are coupled in a refrigerator according to a first embodiment. As illustrated in FIG. 4, a gasket 100 may include a coupling portion 110, a buffer portion 120, and a magnet accommodating portion 130.

The coupling portion 110 may be adjacent to the buffer portion 120, and the buffer portion 120 may be adjacent to the magnet accommodating portion 130. The buffer portion 120 may be provided in plurality and disposed between the coupling portion 110 and the magnet accommodating portion 130.

The door 30 may include a coupling groove 320 to accommodate the coupling portion 110. The coupling groove 320 may be provided inside of an edge of the rear surface of the door 30.

The coupling portion 110 may include an insertion member 111 inserted into the coupling groove 320. The insertion member 111 may include a cavity (not shown) that is hollow and provided inside of the insertion member 111. The cavity (not shown) nay include a reinforcing rib 114 configured to partition the cavity (not shown).

The coupling portion 110 may include a hook 112 provided on one side or both sides of the coupling portion 110 to be locked-coupled to the coupling groove 320. In other words, one hook 112 may be provided on one side of the coupling portion 110, or alternatively one hook 112 may be provided on both sides of the coupling portion 110, respectively and thus two hooks 112 may be provided.

The coupling groove 320 may include a locking protrusion 322 supporting the hook 112.

The hook 112 may be extended in a direction opposite to a direction in which the insertion member 111 is inserted into the coupling groove 320.

As the insertion member 111 is inserted into the coupling groove 320 and the hook 112 is elastically locked to the coupling groove 320, the gasket 100 may be mounted to along a circumference of the rear surface of the door 30.

By the hook 112 locked to the coupling groove 320 and the reinforcing rib 114 provided in the cavity (not shown) of the insertion member 111, the resistance may be formed in a direction opposite to a direction in which the coupling portion 110 is inserted into the coupling groove 320, and thus it may be possible to prevent the gasket 100 from separating from the door 30.

According to embodiments, the gasket 100 of the refrigerator may have a slim shape since a width (A) of a front surface of the gasket 100 has a relatively narrow, and thus by using the gasket 100, it may be possible to minimize the reduction of the aesthetic quality of the overall appearance of the refrigerator 1.

In order to allow the gasket 100 to have a slim shape by reducing the width (A) of the front surface of the gasket 100, the coupling portion 110 of the refrigerator 1 according to embodiments may include a contact surface 113 provided in the other side of the insertion member 111 to be opposite to the hook 112.

According to embodiments, the gasket 100 of the refrigerator 1 may be provided such that a single hook 112 is provided on one side of the insertion member 111 and the contact surface 113 instead of the hook 112 is provided on the other side of the insertion member 111 opposite to the hook 112.

Since a width of the contact surface 113 is relatively less than the width of the hook 112, it may be possible to reduce a first length (A) corresponding to the width of the front surface of the gasket 100.

The contact surface 113 may be in close contact with the coupling groove 320 to reduce the width (A) of the front surface of the gasket 100 that is exposed to the outside upon opening the door 30.

The coupling groove 320 may include a coupling surface 323 disposed opposite to the locking protrusion 322 and to be in surface contact with the contact surface 113. The coupling surface 323 may be provided in a flat shape that is different from the shape of the locking protrusion 322 formed in a curved shape.

The contact surface 113 may he in parallel contact with the coupling surface 323. The coupling surface 323 and the contact surface 113 may be disposed vertically toward the inside of the door 30.

According to embodiments, the width (A) of the front surface of the gasket 100 may be relatively narrow in comparison with a case in which one hook 112 is provided on both sides of the insertion member 111, respectively.

However the shape of the gasket 100 is not limited thereto. The gasket 100 may have various shapes as long as allowing the width (A) of the front surface of the gasket 100 to have a slim shape. For example, one hook 112 may be provided on both sides of the coupling portion 110, respectively and thus two hooks 112 may be provided.

According to embodiments, it may be appropriate that the width (A) of the front surface of the gasket 100, which is exposed to the outside upon opening the door 30 of the refrigerator 1, is approximately 10 mm˜14 mm. In comparison with a case in which a width (A) of a front surface of a gasket of a refrigerator according to the conventional manner is approximately 23 mm˜26 mm, the refrigerator 1 according to embodiments may include the gasket 100 having a relatively narrow width,

The coupling portion 110 may include a support protrusion 115 disposed on the outer side of the insertion member 111. The support protrusion 115 may be provided in plurality. The support protrusion 115 may be in close contact with an inner circumferential surface of the coupling groove 320. The support protrusion 115 may protrude in a direction in which the insertion member 111 is inserted into the coupling groove 320.

Since the support member 115 protrudes toward the outside of the insertion member 111, it may be possible to prevent the cold air from leaking to a gap between the coupling portion 110 and the coupling groove 320.

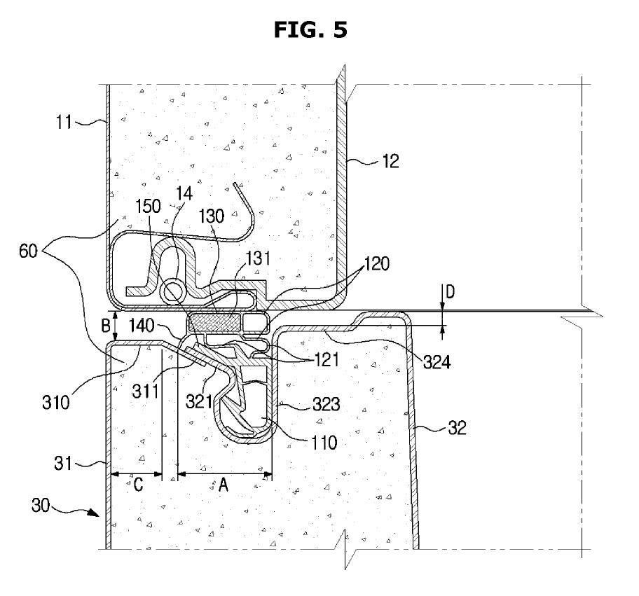

FIG. 5 is a view illustrating the cabinet and the gasket upon closing the door in the refrigerator according to the first embodiment. As illustrated in FIG. 5, according to embodiments, the refrigerator I may include the outer case 11 formed of a metal material.

The gasket 100 may include the magnet accommodating portion 130 in which a magnet 131 is embedded, to seal the storage compartment 20 by allowing the outer case 11 formed of a metal material to be in contact with the door 30.

The magnet accommodating portion 130 may be provided such that the magnet accommodating portion 130 is opposite to the outer case 11 upon closing the door 30. The gasket 100 may be integrally formed with the magnet 131 embedded in the magnet accommodating portion 130.

The gasket 100 may include a cover protrusion 140 configured to prevent the reduction in the aesthetic quality of the outer appearance of the refrigerator 1 by concealing a side surface of the gasket 100, which is exposed between the door 30 and the outer case 11 upon closing the door.

The cover protrusion 140 may be extended toward the door 30 from the magnet accommodating portion 130. The cover protrusion 140 may minimize the exposure of the buffer portion 120 and thus it may possible to make a simple line in terms of the design of the appearance of the refrigerator 1.

The cover protrusion 140 may prevent foreign material from entering into the buffer portion 120.

As the configuration of the cabinet 10, the door 30 may include a door outer panel 31 forming an outer surface thereof, and a door inner panel 32 forming an inner surface thereof.

One side of the gasket 100 may be inserted and fixed to a gap in which the door outer panel 31 and the door inner panel 32 are coupled to each other, and the gasket 100 may be installed along the edge of the door 30.

The door outer panel 31 and the door inner panel 32 may be coupled to each other, and in the same manner as the cabinet 10, an insulation material 60 forming the insulation structure may be foamed between the door outer panel 31 and the door inner panel 32.

The gasket 100 may include a wing protrusion 150 extended from one end portion of the insertion member 111 to an outer edge of the door 30.

The wing protrusion 150 may be adjacent to one end portion of the cover protrusion 140 to prevent the heat loss between the inside of the refrigerator 1 and the outside of the refrigerator 1.

According to embodiments, the wing protrusion 150 of the refrigerator 1 may be obliquely extended from one end portion of the insertion member 111 toward the cabinet 10 to reduce a height (B) of a side surface of the gasket 100, which is exposed upon closing the door 30.

The gasket 100 may be formed in a wedge shape wherein a height of the side surface of the gasket 100 mounted to the door 30 is gradually reduced as the gasket 100 becomes near to the outer edge portion of the door 30.

The door 30 may include an inner panel wing 321 obliquely extended from the locking protrusion 322 to one side edge of the door 30 and configured to be in surface contact with the wing protrusion 150.

The door 30 may include an outer panel wing 311 obliquely provided to be in surface contact with inner panel wing 321.

The wing protrusion 150, the inner panel wing 321, and the outer panel wing 311 may be overlapped with each other. The wing protrusion 150 may be overlapped with the inner panel wing 321. The inner panel wing 321 may be overlapped with the outer panel wing 311.

The inner panel wing 321 may be provided between the wing protrusion 150 and the outer panel wing 311.

The inner panel wing 321 may be made of a plastic material like the inner case 12, and the inner panel wing 321 may be vacuum-formed to be inclined to correspond to a gradient of the outer panel wing 311 made of a metal material.

It may be appropriate that a length of an overlapping portion of the inner panel wing 321 and the outer panel wing 311 may be approximately 4 mm or more, but is not limited thereto.

According to the conventional manner, a wing protrusion, an inner panel wing, and an outer panel wing may be provided horizontally without inclination. Therefore, a height of the side surface of the gasket, which is exposed to between the door and the outer case upon closing the door, may be a relatively long and thus it may be possible to reduce the aesthetic quality of the appearance of the refrigerator.

According to embodiments, the refrigerator 1 is provided such that the wing protrusion 150, the inner panel wing 321, and the outer panel wing 311 of the gasket 100 are overlapped Obliquely toward the cabinet 10, and thus a height of the side surface of the gasket 100, which is exposed to between the door 30 and the outer case 11 upon closing the door, may be a relatively small.

Since the height (B) of the side surface of the gasket 100 that is exposed is relatively small, it may be possible to minimize the reduction in the aesthetic quality of the appearance of the refrigerator 1.

In order to reduce a second length (B), which corresponds to the height of the side surface of the gasket 100 exposed to the outside of the door 30, the gasket 100 may be formed in a shape in which a height thereof is reduced from the contact surface 113 to an outer edge portion of the door 30.

It may be appropriate that the height (B) of the side surface of the gasket 100, which is exposed to the outside upon closing the door, is approximately 3 mm˜5 mm, but is not limited thereto.

The door 30 may include a covering surface 310 bent from the outer panel wing 311 and extended toward one side edge of the door 30.

The covering surface 310 may be opposed in parallel with the outer case 11 when the door 30 is closed. The covering surface 310 may be provided horizontally.

It may be appropriate that a width (C) of the covering surface 310 is approximately 10 mm˜12 mm, but is not limited thereto.

The width (C) of the covering surface 310 may be greater or less than the width (A) of the front surface of the gasket 100. In addition, the width (C) of the covering surface 310 may be the same as the width (A) of the front surface of the gasket 100.

It may be appropriate that the outer panel wing 311 is inclined at approximately 25 equal to or greater than degree toward the other side edge portion of the door 30 with respect to the covering surface 310, but is not limited thereto.

The door 30 may include an inner panel liner 324 bent from the coupling surface 323 and extended toward the other side edge portion of the door 30.

The inner case 12 opposite to the inner panel liner 324 may form a cavity having a first distance (I)) between the inner panel liner 324 and the inner case 12.

The magnet accommodating portion 130 and the buffer portion 120 may be connected and form an approximately flat surface in parallel with the outer case 11.

In order to reduce an amount of energy discharging from the inside to the outside of the refrigerator 1, the buffer portion 120 in parallel with the magnet accommodating portion 130 may form a step portion with the surface of the magnet accommodating portion 130 or alternatively the buffer portion 120 may have a convex shape toward the storage compartment 20.

The shape of the surface of the buffer portion 120 which is not parallel to the surface of the magnet accommodating portion 130 may deteriorate the appearance of the refrigerator 1.

According to embodiments, the surface of the magnet accommodating portion 130 and the surface of the buffer portion 120 may form a flat surface without a step portion and thus the refrigerator 1 may improve the design of the appearance of the refrigerator 1 while maintaining the existing functions of the refrigerator 1.

In order to achieve the unity in the overall design on the rear surface of the door 30, the first distance (D) between the inner panel liner 324 and the inner case 12 and a second distance (B) between the covering surface 310 and the outer case 11 may be determined.

It may be appropriate that the first distance (D) is approximately 1.5 mm and 2.5 mm, but is not limited thereto.

The gasket 100 may include a second wing protrusion (not shown) protruding toward the door 30 in a direction away from the cover protrusion 140 from the buffer portion 120 adjacent to the magnet accommodating portion 130.

The second wing protrusion (not shown) may reduce the distance between the gasket 100 and the door 30 and maintain the sealing force of the inside of the refrigerator 1.

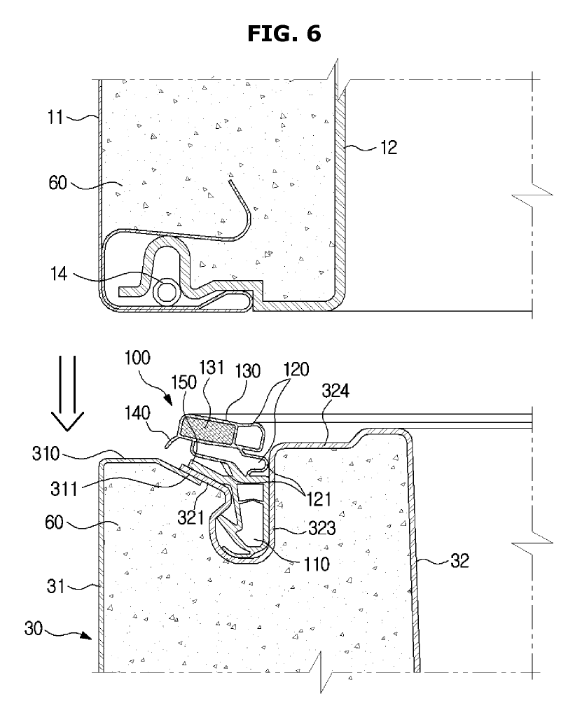

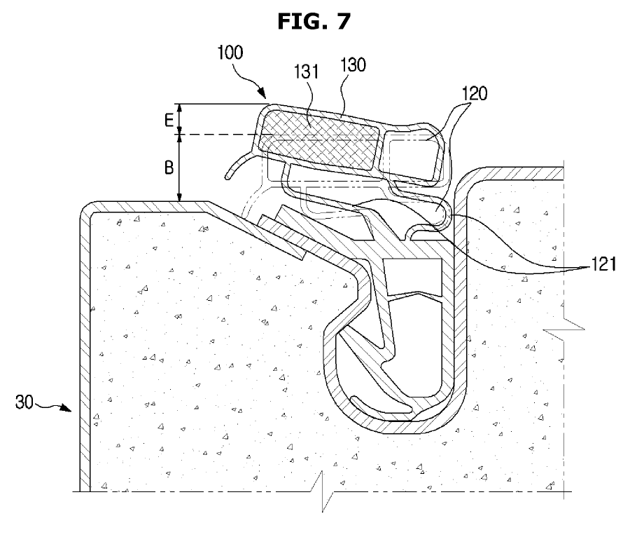

FIG. 6 is a view illustrating a case in which the cabinet and the gasket when the door is opened in the refrigerator according to the first embodiment. FIG. 7 is a view illustrating a stretching structure of the gasket in the refrigerator according to the first embodiment.

As illustrated in FIGS. 6 and 7, according to embodiments, when the door 30 is opened or closed, the door 30 and the cabinet 10 of the refrigerator 1 may receive the impact.

The gasket 100 may mitigate the impact occurred between the door 30 and the cabinet 10.

The gasket 100 may include at least one buffer portion 120 to mitigate the impact. The buffer portion 120 may typically protect the door 30 and the cabinet 10 from the impact, which is occurred upon opening and closing the door 30, by using the cushioning of air.

The buffer portion 120 may include an elastic member 121 so that the gasket 100 may have a stretching structure configured to absorb the impact occurred upon opening and closing the door 30.

The elastic member 121 may form other buffer portion 120 inside of the gasket 100.

When a gap is generated between the door 30 and the cabinet 10 depending on whether the door 30 is opened and closed, the elastic member 121 may be repeatedly stretched and contracted to maintain the sealing force of the inside of the refrigerator 1.

The elastic member 121 may have at least one bent portion.

Since the inside of the buffer portion 120 has a complicated partition structure, it may be possible to absorb the impact between the door 30 and the cabinet 10 and it may be possible to reduce the energy consumption of the refrigerator 1 by minimizing the heat loss caused by the temperature difference between the inside and the outside of the cabinet 10.

Generally, the material of the gasket 100 may include Polyvinyl Chloride (PVC).

When molding the gasket 100 by using PVC, a step of compressing the gasket 100 at a high temperature may be included and when the elastic member 121 has a shape bent toward the cover protrusion 140, the elastic member 121 may be adhered to the cover protrusion 140 by the deformation by the heat.

To prevent this, the elastic member 121 of the refrigerator 1 according to embodiments may have a shape that is bent or curved in a direction away from the cover protrusion 140 so as to be apart from the cover protrusion 140.

Generally, a surface of the gasket 100 in contact with the outer case 11 may have a smooth flat surface. A surface of the magnet accommodating portion 130 in contact with the outer case 11 may have a smooth flat surface.

When the door 30 is closed, the surface of the magnet accommodating portion 130 may be in close contact with the outer case 11 and thus the storage compartment 20 may be sealed. The magnet 131 embedded in the magnet accommodating portion 130 may be attached to the outer case 11 formed of a metal material, and thus the sealing force of the storage compartment 20 may be increased.

As for the refrigerator 1, when the internal pressure of the storage compartment 20 is reduced due to the temperature difference between the inside and the outside of the storage compartment 20, the door 30 may be more firmly closed and the gasket 100 may come close to the side of the outer case 11 thereby having a completely sealed structure.

A hot line 14 in which a high-temperature and high-pressure refrigerant flows may be installed between the outer case 11 and the inner case 12 to prevent the dew condensation,

The heat of the hot line 14 may be transmitted to the surface of the magnet accommodating portion 130 in surface contact with the outer case 11 and thus the gasket 100 may be deformed into being relatively soft by the heat of the hot line 14.

Since the soft gasket 10( )has a higher adhesion force, the adhesion force between the door 30 and the outer case 11 may be increased.

Since the soft gasket 100 is in surface contact with the outer case 11, the adhesion force of the gasket 100 may be increased and thus when the door 30 is opened, a repulsive force may be strongly applied to the gasket 100 in a direction opposite to the direction in which the door 30 is opened.

According to embodiments, the refrigerator 1 may include the gasket 100 having a stretching structure in which a height is increased.

The gasket 100 may include the stretching structure in which a stretch and a contraction are repeatedly performed, to prevent the deformation thereof upon opening and closing the door 30.

The buffer portion 120 may include the elastic member 121 having an elastic force to absorb the deformation to have the stretching structure.

It may be appropriate that a variable height (E) of the gasket 100, which is stretched by the elastic member 121 upon opening and closing the door 30, is approximately 4 mm or more, but is not limited thereto.

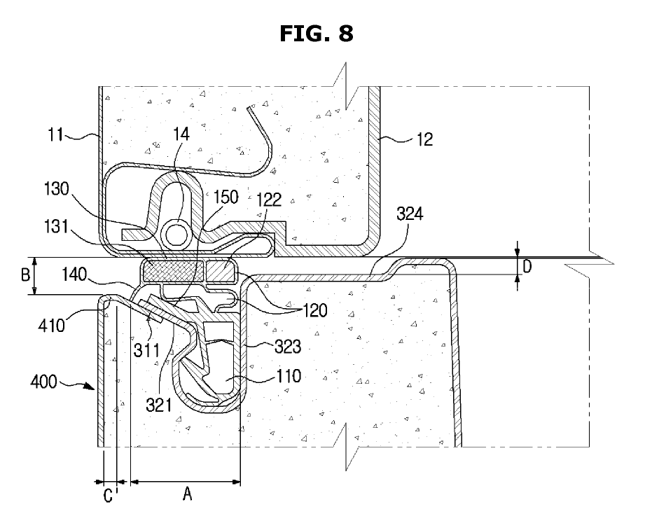

FIG. 8 is a view illustrating a cabinet and a gasket when a door is closed in a refrigerator according to a second embodiment.

As illustrated in FIG. 8, a refrigerator 1 according to the second embodiment may include a covering surface 410 bent from an outer panel wing 311 and extended to an outer edge of a door 400.

According to the second embodiment, the covering surface 410 of the refrigerator 1 may have a width (C′) relatively less than the width (C) of the covering surface 310 of the refrigerator 1 according to the first embodiment.

It may be appropriate that the width (C′) of the covering surface 410 is approximately 3 mm˜6 mm, but is not limited thereto.

Since the width (C′) of the covering surface 410 of the refrigerator 1 according to the second embodiment is relatively narrow, the gasket 100 may be placed closer to the outer edge of the door 400 in comparison with the refrigerator 1 according to the first embodiment.

The gasket 100 may be mounted to the door 400 such that the hot line 14 is placed to correspond to the width (A) of the front surface of the gasket 100 upon closing the door 400.

The gasket 100 may be placed in the door 400 such that a cross section of the hot line 14 corresponds to a cross section of the magnet accommodating portion 130.

The buffer portion 120 may accommodate air therein. The buffer portion 120 may accommodate a buffer member 122 having a lower thermal conductivity than the air therein. The buffer member 122 may include a variety of materials such as PU foam.

Since the buffer member 122 has a lower thermal conductivity than air, the heat loss of the refrigerator 1 may be minimized.

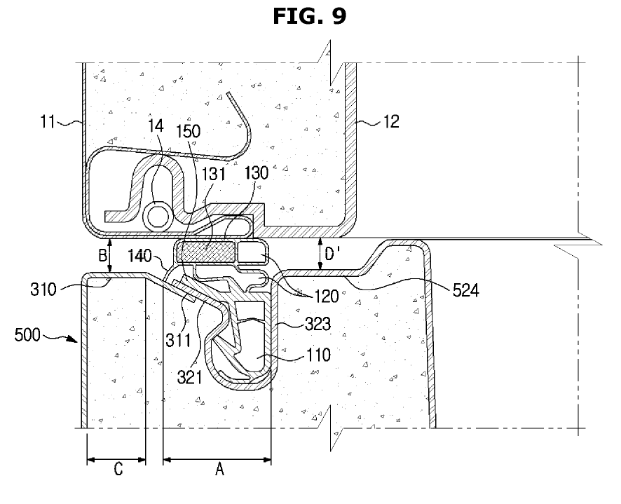

FIG. 9 is a view illustrating a cabinet and a gasket when a door is closed in a refrigerator according to a third embodiment. As illustrated in 9, a refrigerator 1 according to the third embodiment may include an inner panel liner 524 bent and extended from a coupling surface 323.

The inner panel liner 524 may form a cavity having a first distance (D′) with an inner case 12 opposite to the inner panel liner 524.

In order to achieve the unity in the overall design on the rear surface of a door 500, the first distance (D′) between the inner panel liner 524 and the inner case 12 and a second distance (B) between a covering surface 310 and an outer case 11 may be determined.

According to the third embodiment, it may be appropriate that the first distance (D′) of the refrigerator 1 is approximately 3 mm and 5 mm, but is not limited thereto.

The first distance (D′) may be the same as the second distance (B).

According to the third embodiment, the refrigerator I may include a door 500 in which the overall unity is achieved from the covering surface 310, the surface of the magnet accommodating portion 130 in contact with the outer case 11, the surface of the buffer portion 120 to the inner panel liner 524.

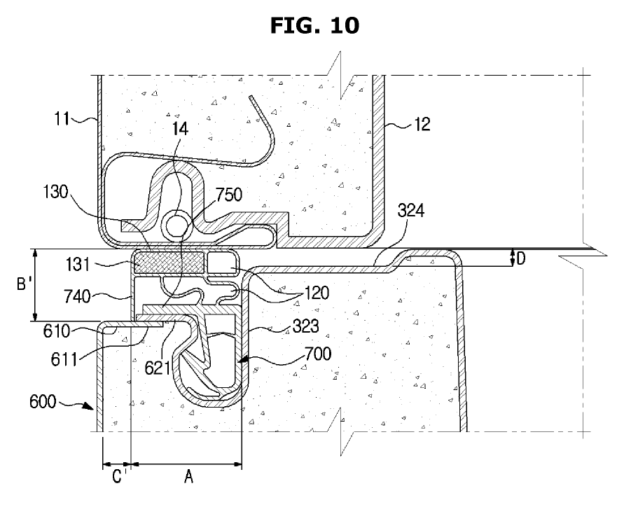

FIG. 10 is a view illustrating a cabinet and a gasket when a door is closed in a refrigerator according to a fourth embodiment.

As illustrated in FIG. 10, as for a refrigerator 1 according to the fourth embodiment, a height (B′) of a side surface of a gasket 700, which is exposed to the outside upon closing a door 600, may be relatively greater in comparison with the refrigerator 1 according to the first embodiment.

A wing protrusion 750 of the gasket 700 may be extended horizontally toward the outside of the door 600 without inclination, and an inner panel wing 621 and an outer panel wing 611 of the door 600 may be horizontally overlapped with the wing protrusion 750.

According to the fourth embodiment, a cover protrusion 740 of the refrigerator 1 may be extended from the magnet accommodating portion 130 toward the door 600 in a direction perpendicular to the wing protrusion 750.

It may be appropriate that the height (B′) of the side surface of the gasket 700 is approximately 9 mm˜10 mm upon closing the door 600, but is not limited thereto.

According to the fourth embodiment, in order to reduce the width (A) of the front surface of the gasket 700 in the same manner as the refrigerator 1 according to the first embodiment, the refrigerator 1 may include a single hook 112 and a contact surface 133 opposite to the hook 112.

As is apparent from the above description, the proposed refrigerator can improve the design of the appearance thereof while maintaining the sealing force and shock absorbing function of the gasket by changing only the shape of the gasket.

Even with the reduction in the width of the front surface and the height of the side surface of the gasket that is exposed to the outside to improve the design of the appearance of the refrigerator, the proposed refrigerator can prevent the deterioration of the dew condensation while maintaining the insulation performance as it is or improve the insulation performance to a better level.

Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. A refrigerator comprising:
a cabinet provided with an outer case and an inner case;
a storage compartment provided inside of the cabinet;
a door rotatably coupled to the cabinet to open or close the storage compartment and provided with a coupling groove disposed on a rear surface of the door; and
a gasket mounted to the coupling groove to seal the storage compartment,
wherein the gasket comprises
an insertion member inserted into the coupling groove and provided with a contact surface configured to be in close contact with one side of the coupling groove;
a hook provided on a side opposite to the contact surface to be coupled to the other side of the coupling groove; and
a wing protrusion obliquely extended from one end side of the insertion member.

2. The refrigerator of claim 1, wherein the gasket is formed in a wedge shape wherein a length of a side surface of the gasket, which is exposed to the outside of the door, is reduced as the gasket becomes near to an outer edge portion of the door.

3. The refrigerator of claim 1, wherein a length of a side surface of the gasket, which is exposed between the cabinet and the door upon closing the door, is provided in a range of about 3 mm to 5 mm.

4. The refrigerator of claim 1, wherein the coupling groove comprises a locking protrusion configured to support the hook and a coupling surface disposed opposite to the locking protrusion to be in surface contact with the contact surface.

5. The refrigerator of claim 1, wherein a width of the gasket is provided in a range of 10 mm to 14 mm.

6. The refrigerator of claim 4, wherein the door comprises an inner panel wing obliquely extended from the locking protrusion to an outer edge of the door and configured to be in surface contact with the wing protrusion.

7. The refrigerator of claim 6, wherein the door comprises an outer panel wing obliquely provided to be in surface contact with inner panel wing and a covering surface bent from the outer panel wing and extended toward the outer edge of the door.

8. The refrigerator of claim 7, wherein a width of the covering surface is greater than a width of the gasket.

9. The refrigerator of claim 7, wherein the outer panel wing is inclined at about 25 degrees or greater toward the inside of the door with respect to the covering surface.

10. The refrigerator of claim 1, wherein the gasket further comprises a magnet accommodating portion configured to accommodate a magnet and installed to be in close contact with the outer case, and a buffer portion adjacent to the magnet accommodating portion and configured to accommodate a buffer member having a thermal conductivity lower than that of air.

11. The refrigerator of claim 1, wherein the cabinet further comprises a hot line disposed between the outer case and the inner case, wherein the hot line is disposed to correspond to the gasket configured to be in close contact with the outer case upon closing the door.

12. The refrigerator of claim 10, wherein the buffer portion comprises an elastic member so that the gasket has a stretching structure configured to absorb the impact occurred upon closing or opening the door.

13. The refrigerator of claim 12, wherein a length of a side surface of the gasket, which is stretched by the elastic member upon closing or opening the door, is equal to or greater than about 4 mm.

14. The refrigerator of claim 7, further comprising:
an inner panel liner bent from the coupling surface and extended toward the inside of the door upon closing the door,
wherein the inner panel liner is separated from the inner case opposite to the inner panel liner, by a first distance.

15. The refrigerator of claim 14, wherein a second distance between the covering surface and the outer case opposite to the covering surface is the same as the first distance.

16. A refrigerator comprising:
a cabinet provided with an outer case and an inner case and configured to accommodate a storage compartment;
a door configured to open or close the storage compartment and provided with a door inner panel and a door outer panel; and
a gasket installed between the cabinet and the door to close the storage compartment,
wherein the door comprises
a coupling groove disposed in a rear surface of the door;
a covering surface bent from one end of the door outer panel and extended toward the inside of the door, and configured to be opposite to the outer case upon closing the door;
an outer panel wing obliquely extended from the covering surface; and
an inner panel wing obliquely provided to be in surface contact with the outer panel wing.

17. The refrigerator of claim 16, wherein the gasket comprises a buffer portion configured to absorb an impact occurred upon closing the door; and
a coupling portion adjacent to the buffer portion and mounted to the coupling groove by having a wing protrusion obliquely provided to be in surface contact with the inner panel wing.

18. The refrigerator of claim 17, wherein the coupling portion further comprises a contact surface configured to be in parallel contact with one side of the coupling groove.

19. A refrigerator comprising:
a cabinet;
a door rotatably coupled to the cabinet and provided with a locking protrusion disposed on an edge portion of a rear surface thereof and a coupling surface opposite to the locking protrusion; and
a gasket provided with a hook configured to be locked to the locking protrusion, so as to be mounted to the door,
wherein the gasket comprises a contact surface disposed opposite to the hook and configured to be in parallel contact with the coupling surface, so as to reduce a width of the gasket.

20. The refrigerator of claim 19, wherein the gasket has a shape in which a length of a side surface of the gasket, which is exposed between the cabinet and the door upon closing the door, is reduced as the gasket becomes near to an outer edge of the door.
